(19) United States
(12) Patent Application Publication
(10) Pub. No.: US 2025/0010433 A1
(43) Pub. Date: Jan. 9, 2025

(54) Pivot Hammer Pipe Wrench Device

(71) Applicant: Justin Smith, Woodstock, VA (US)

(72) Inventor: Justin Smith, Woodstock, VA (US)

(21) Appl. No.: 18/738,718

(22) Filed: Jun. 10, 2024

Related U.S. Application Data
(60) Provisional application No. 63/512,339, filed on Jul. 7, 2023.

(51) Int. Cl. B25B 13/48; B25B 13/50

(52) U.S. Cl. CPC B25B 13/481; B25B 13/5058

(57) ABSTRACT

A pipe wrench pivot device is disclosed that is capable of pivoting for increased force. The pipe wrench pivot device comprises a handle component and attached head component that are configured in a conventional pipe wrench shape. The handle component comprises a pivot steel pin that can be locked and unlocked. The pin allows the device to unlock and pivot on the pin, thereby creating additional force when swung. The device is ideal for use in confined spaces and maximizes force and torque using inertia.

### CROSS-REFERENCE TO RELATED APPLICATION

The present application claims priority to, and the benefit of, U.S. Provisional Application No. 63/512,339, which was filed on Jul. 7, 2023, and is incorporated herein by reference in its entirety.

### FIELD OF THE INVENTION

The present invention relates generally to the field of pipe wrench pivot devices. More specifically, the present invention relates to a modified pipe wrench capable of pivoting to increase force applied to nuts. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in pipe wrench pivot devices. Generally, standard pipe wrenches may require significant strength and dexterity to operate. Further, trying to use a pipe wrench in tight spaces can be difficult and requires a hammer to put enough pressure on the wrench handle for it to turn. Accordingly, operators may need larger pipe wrenches to produce additional force.

Furthermore, many jobs require the use of additional force and inertia on the pipe wrench. Additionally, tradespeople, mechanics, etc., may need to utilize pipe wrenches in tight spaces. These people may need to utilize a hammer to get the additional force and inertia required, in such tight spaces.

Accordingly, there is a demand for an improved pipe wrench pivot device that increases the force applied to nuts, bolts, and other objects. More particularly, there is a demand for a pipe wrench pivot device that allows users to easily apply pipe wrenches in tighter spaces while maximizing force and torque.

Therefore, there exists a long felt need in the art for a pipe wrench pivot device that provides users with a modified pipe wrench capable of pivoting to increase force applied to nuts, bolts, and other objects. There is also a long felt need in the art for a pipe wrench pivot device that includes a pivoting steel pin in the handle that can be locked or unlocked, creating additional force when swung. Further, there is a long felt need in the art for a pipe wrench pivot device that allows users to easily apply pipe wrenches in tighter spaces while maximining force and torque. Moreover, there is a long felt need in the art for a device that saves time and effort for any mechanic, maintenance workers, and numerous other tradespeople. Further, there is a long felt need in the art for a pipe wrench pivot device that comprises a pin that allows the device to unlock and pivot on the pin. Finally, there is a long felt need in the art for a pipe wrench pivot device that can be used in tight spaces without the need for a hammer.

The subject matter disclosed and claimed herein, in one embodiment thereof, comprises a pipe wrench pivot device. The device is a pipe wrench capable of pivoting for increased force. The pipe wrench pivot device comprises of a handle component and attached head component that are configured in a conventional pipe wrench shape. The handle component comprises a pivot steel pin that can be locked and unlocked. The pin allows the device to unlock and pivot on the pin, thereby creating additional force when swung. The device is ideal for use in confined spaces and maximizes force and torque using inertia. Further, the increased force and inertia on the device helps improve pipe wrench designs for tradespeople, mechanics, and more. Thus, users can apply the pipe wrench in tight spaces without the need for a hammer.

In this manner, the decorative container device of the present invention accomplishes all of the forgoing objectives and provides users with a device that provides increased force and inertia for a pipe wrench. The device includes a pivoting steel pin in the handle. The device saves time and effort for a mechanic, maintenance worker, etc.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pipe wrench pivot device. The device is a pipe wrench capable of pivoting for increased force. The pipe wrench pivot device comprises a handle component and attached head component that are configured in a conventional pipe wrench shape. The handle component comprises a pivot steel pin that can be locked and unlocked. The pin allows the device to unlock and pivot on the pin, thereby creating additional force when swung. The device is ideal for use in confined spaces and maximizes force and torque using inertia. Further, the increased force and inertia on the device helps improve pipe wrench designs for tradespeople, mechanics, and more. Thus, users can apply the pipe wrench in tight spaces without the need for a hammer.

In one embodiment, the pipe wrench pivot device creates additional force when swung and can be applied in tight spaces and where increased force is needed. The pipe wrench pivot device allows users to easily apply pipe wrenches in tighter spaces while maximizing force and torque.

In one embodiment, the pipe wrench pivot device comprises a handle component with an attached head component. The head component is sized and shaped as a conventional pipe wrench. Specifically, the head component comprises two jaws, one is a fixed jaw and another is movable jaw. A linear movement is imparted to the movable jaw by a mechanism similar to a screw and nut arrangement. Thus, a linear movement of the movable jaw is possible either towards or away from the fixed jaw and is imparted by the rotatable movement of a nut. When the pipe is held between the jaws of the wrench head component, the pipe wrench device is operated so as to release or tighten the grip on the pipe. Accordingly, for each operation the jaws are to be adjusted for gripping or release of the pipe by actuation of the nut. Thus, the nut is actuated so that the jaws grip the pipe and then rotatable movement of the nut is repeated to release the pipe.

In one embodiment, the fixed jaw and/or the movable jaw of the head component have a curved serrated outer edge for better grip.

In one embodiment, the handle component is formed as a flat box-like or tubular structure, with a first end and a second end. A second end of the handle component is adapted to be gripped by the user in connection with use of the wrench. The first end of the handle component is secured to the head component. The first end is secured to the head component via a threaded connection, a pin connection, a rotatable connection, etc., or any other suitable connection as is known in the art.

In one embodiment, the handle component also comprises a bottom grip section and a top section secured together via a pivot steel pin. In operation, the handle component is pivoted on the pin. Typically, the pivot steel pin is secured between the bottom grip section and the top section. Specifically, a protrusion is positioned at the top of the bottom grip section, which is sized and shaped to fit within a cavity of the top section. The cavity and the protrusion both have a through-hole on either side, which align, such that the pivot steel pin fits within the through-holes. The pivot steel pin is swaged at its end, or a nut is inserted at its end, or the pivot steel pin is threaded within the through-hole to secure the pin in place. The pivot pin extends through the through-holes of the protrusion and cavity to releasably secure the handle component in its operative or normal position. In use, the head component is secured to a pipe, then the handle component is pivoted or ratcheted up and down creating more force and torque via the pivot steel pin. Specifically, the pivot pin secured to the handle component forms a pivotal connection whereby the bottom grip section may be ratcheted upwards and downwards, to a limited extent relative to the top section of the handle component. Thus, the pivot pin permits the bottom grip section to rock or swing relatively to the top section of the handle component.

In one embodiment, the pivot steel pin can be locked and unlocked, as needed. Further, the pivot steel pin would have a spring and release, which allows a user to lock the unlock the pivoting pin. The spring would engage a feature of the handle component to lock the handle component in place. Further, a lever or button or other means could be utilized to unlock the pivot pin, such that a user engaging the lever or button, pushes on the spring to unlock it.

In one embodiment, the bottom grip section of the handle component comprises a gripping texture or other suitable means for aiding a user in gripping the handle component during use.

In operation, a user adjusts the head component so as to space apart the jaws to the proper extent to receive the pipe. The adjustment is effected by turning the screw in one direction or the other depending upon whether it is desired to move the movable jaw to or from the fixed jaw. After the head component is properly adjusted so that the jaws are set or positioned to receive the pipe, the handle component is grasped and the handle component pivoted up and down.

The herein described wrench device is extremely efficient so far as operation is concerned and involves a rugged construction which tends towards durability. It may be produced at a reasonably low cost and is useable in connection with pipes in tight, inaccessible places, such, for example, as overhead pipes or pipes in corners or against walls or floors.

In yet another embodiment, the pipe wrench pivot device comprises a plurality of indicia.

In yet another embodiment, a method of increasing force and inertia on a pipe wrench. The method includes the steps of providing a pipe wrench pivot device comprising a handle component and attached head component with a pivot steel pin in the handle component. The method also comprises securing the head component around a pipe for use. Further, the method comprises pivoting on the steel pin and creating more force when utilizing the wrench. Finally, the method comprises increasing the force and inertia on the pipe wrench during use.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-C illustrate a perspective view of one embodiment of the pipe wrench pivot device of the present invention showing the device from different angles in accordance with the disclosed architecture;

FIG. 2 illustrates a perspective view of one embodiment of the pipe wrench pivot device of the present invention showing the handle component of the device in accordance with the disclosed architecture;

FIG. 3 illustrates a perspective view of one embodiment of the pipe wrench pivot device of the present invention showing the device with the pivot steel pin in accordance with the disclosed architecture;

FIG. 4 illustrates a perspective view of one embodiment of the pipe wrench pivot device of the present invention showing a close-up view of the pivot steel pin in accordance with the disclosed architecture;

FIG. 5 illustrates a perspective view of one embodiment of the pipe wrench pivot device of the present invention showing the device on its side in accordance with the disclosed architecture; and

FIG. 6 illustrates a flowchart showing the method of increasing force and inertia on a pipe wrench in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a pipe wrench pivot device that provides users with a modified pipe wrench capable of pivoting to increase force applied to nuts, bolts, and other objects. There is also a long felt need in the art for a pipe wrench pivot device that includes a pivoting steel pin in the handle that can be locked or unlocked, creating additional force when swung. Further, there is a long felt need in the art for a pipe wrench pivot device that allows users to easily apply pipe wrenches in tighter spaces while maximining force and torque. Moreover, there is a long felt need in the art for a device that saves time and effort for any mechanic, maintenance workers, and numerous other tradespeople. Further, there is a long felt need in the art for a pipe wrench pivot device that comprises a pin that allows the device to unlock and pivot on the pin. Finally, there is a long felt need in the art for a pipe wrench pivot device that can be used in tight spaces without the need for a hammer.

The present invention, in one exemplary embodiment, is a novel pipe wrench pivot device. The device is a pipe wrench capable of pivoting for increased force. The pipe wrench pivot device comprises of a handle component and attached head component that are configured in a conventional pipe wrench shape. The handle component comprises a pivot steel pin that can be locked and unlocked. The pin allows the device to unlock and pivot on the pin, thereby creating additional force when swung. The device is ideal for use in confined spaces and maximizes force and torque using inertia. The present invention also includes a novel method of increasing force and inertia on a pipe wrench. The method includes the steps of providing a pipe wrench pivot device comprising a handle component and attached head component with a pivot steel pin in the handle component. The method also comprises securing the head component around a pipe for use. Further, the method comprises pivoting on the steel pin and creating more force when utilizing the wrench. Finally, the method comprises increasing the force and inertia on the pipe wrench during use.

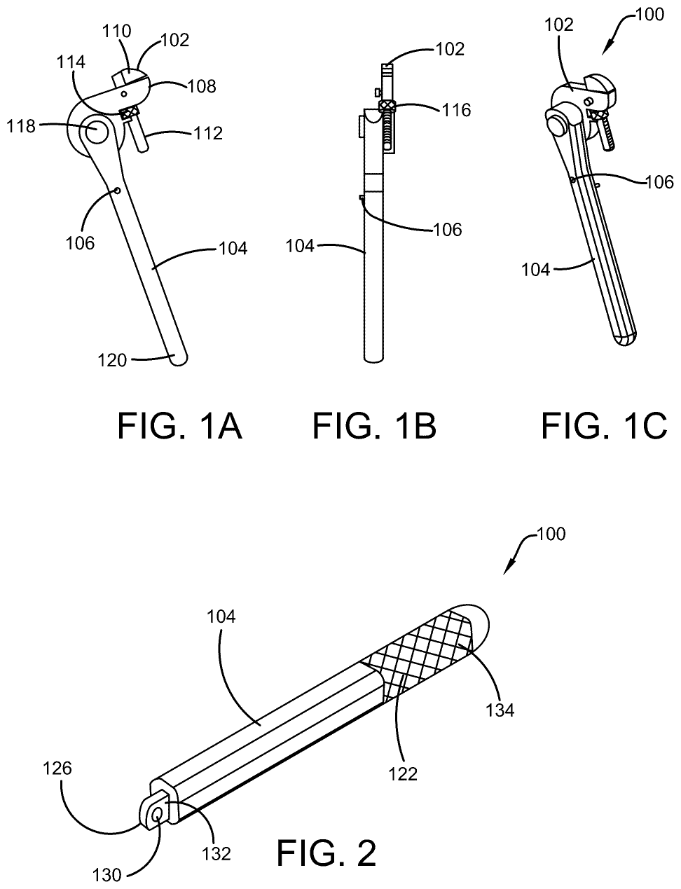

Referring initially to the drawings, FIGS. 1A-C illustrate a perspective view of one embodiment of the pipe wrench pivot device 100 of the present invention. In the present embodiment, the pipe wrench pivot device 100 is an improved pipe wrench pivot device 100 that provides a user with a pipe wrench capable of pivoting to increase force. Specifically, the pipe wrench pivot device 100 comprises a handle component 104 with an attached head component 102 and a pivot steel pin 106 in the handle component 104. The pin 106 allows the device 100 to pivot, thereby creating additional force when swung. The device 100 is ideal for use in confined spaces and maximizes force and torque using inertia. Further, the increased force and inertia on the device 100 helps improve pipe wrench designs for tradespeople, mechanics, and more. Thus, users can apply the pipe wrench device 100 in tight spaces without the need for a hammer.

Generally, the pipe wrench pivot device 100 creates additional force when swung and can be applied in tight spaces and where increased force is needed. The pipe wrench pivot device 100 allows users to easily apply pipe wrenches in tighter spaces while maximizing force and torque.

Further, the pipe wrench pivot device 100 comprises a handle component 104 with an attached head component 102. The head component 102 is sized and shaped as a conventional pipe wrench. Specifically, the head component 102 comprises two jaws 108, 110, one is a fixed jaw 108 and another is a movable jaw 110. A linear movement is imparted to the movable jaw 110 by a mechanism similar to a screw 112 and nut 114 arrangement. Thus, a linear movement of the movable jaw 110 is possible either towards or away from the fixed jaw 108 and is imparted by the rotatable movement of a nut 114. When the pipe is held between the jaws 108, 110 of the wrench head component 102, the pipe wrench device 100 is operated so as to release or tighten the grip on the pipe. Accordingly, for each operation the jaws 108, 110 are to be adjusted for gripping or release of the pipe by actuation of the nut 114. Thus, the nut 114 is actuated so that the jaws 108, 110 grip the pipe and then rotatable movement of the nut 114 is repeated to release the pipe.

In one embodiment, the fixed jaw 108 and/or the movable jaw 110 of the head component 102 have a curved serrated outer edge 116 for better grip of the pipe. The serrated outer edge 116 can be straight or curved depending on the wants and/or needs of a user.

Furthermore, the handle component 104 is formed as a flat box-like or tubular structure, with a first end 118 and a second end 120. A second end 120 of the handle component 104 is adapted to be gripped by the user in connection with use of the wrench device 100. The first end 118 of the handle component 104 is secured to the head component 102. The first end 118 is secured to the head component 102 via a threaded connection, a pin connection, a rotatable connection, etc., or any other suitable connection as is known in the art.

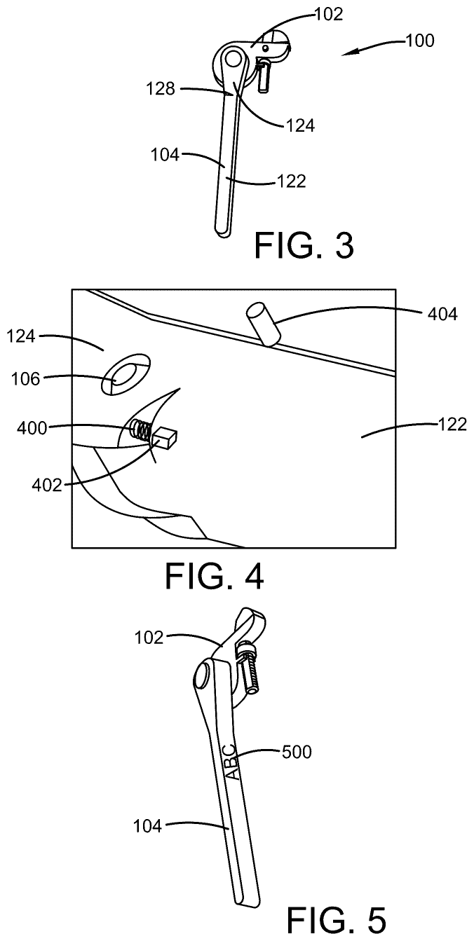

As shown in FIGS. 2-3, the handle component 104 also comprises a bottom grip section 122 and a top section 124 secured together via a pivot steel pin 106. In operation, the handle component 104 is pivoted on the pin 106. Typically, the pivot steel pin 106 is secured between the bottom grip section 122 and the top section 124. Specifically, a protrusion 126 is positioned at the top of the bottom grip section 122, which is sized and shaped to fit within a cavity 128 of the top section 124. The cavity 128 and the protrusion 126 both have a through-hole 130 on either side 132, which align, such that the pivot steel pin 106 fits within the through-holes 130. The pivot steel pin 106 is swaged at its end, or a nut is inserted at its end, or the pivot steel pin 106 is threaded within the through-hole 130 to secure the pin 106 in place. The pivot pin 106 extends through the through-holes 130 of the protrusion 126 and cavity 128 to releasably secure the handle component 104 in its operative or normal position. In use, the head component 102 is secured to a pipe, then the handle component 104 is pivoted or ratcheted up and down creating more force and torque via the pivot steel pin 106. Specifically, the pivot pin 106 secured to the handle component 104 forms a pivotal connection whereby the bottom grip section 122 may be ratcheted upwards and downwards, to a limited extent relative to the top section 124 of the handle component 104. Thus, the pivot pin 106 permits the bottom grip section 122 to rock or swing relatively to the top section 124 of the handle component 104.

In one embodiment, the bottom grip section 122 of the handle component 104 comprises a gripping texture 134 or other suitable means for aiding a user in gripping the handle component 104 during use.

As shown in FIG. 4, the pivot steel pin 106 can be locked and unlocked, as needed. Further, the pivot steel pin 106 would have a spring 400 and release 402, which allows a user to lock and unlock the pivoting pin 106. The spring 400 would engage a feature of the handle component 104 to lock the handle component 104 in place. Further, a lever 404 or button or other means could be utilized to unlock the pivot pin 106, such that a user engaging the lever 404 or button, pushes on the spring 400 to unlock it.

As shown in FIG. 5, the wrench device 100 is extremely efficient so far as operation is concerned and involves a rugged construction which tends towards durability. It may be produced at a reasonably low cost and is useable in connection with pipes in tight, inaccessible places, such, for example, as overhead pipes or pipes in corners or against walls or floors.

In operation, a user adjusts the head component 102 so as to space apart the jaws 108, 110 to the proper extent to receive the pipe. The adjustment is effected by turning the screw 112 in one direction or the other depending upon whether it is desired to move the movable jaw 110 to or from the fixed jaw 108. After the head component 102 is properly adjusted so that the jaws 108, 110 are set or positioned to receive the pipe, the handle component 104 is grasped and the handle component 104 pivoted up and down.

In yet another embodiment, the pipe wrench pivot device 100 comprises a plurality of indicia 500. The head component 102 and the handle component 104 of the device 100 may include advertising, a trademark, or other letters, designs, or characters, printed, painted, stamped, or integrated into the head component 102 and the handle component 104, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be pipe wrench, pipes, or brand related.

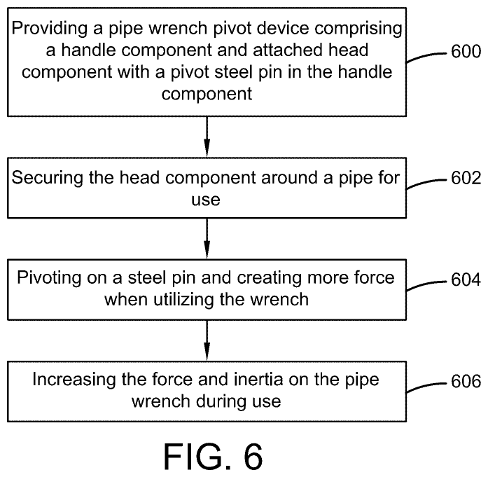

FIG. 6 illustrates a flowchart of the method of increasing force and inertia on a pipe wrench. The method includes the steps of at 600, providing a pipe wrench pivot device comprising a handle component and attached head component with a pivot steel pin in the handle component. The method also comprises at 602, securing the head component around a pipe for use. Further, the method comprises at 604, pivoting on the steel pin and creating more force when utilizing the wrench. Finally, the method comprises at 606, increasing the force and inertia on the pipe wrench during use.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pipe wrench pivot device”, “pipe wrench device”, “pivot device”, and “device” are interchangeable and refer to the pipe wrench pivot device 100 of the present invention.

Notwithstanding the forgoing, the pipe wrench pivot device 100 of the present invention can be of any suitable size and configuration as is known in the art without affecting the overall concept of the invention, provided that it accomplishes the above stated objectives. One of ordinary skill in the art will appreciate that the pipe wrench pivot device 100 as shown in FIGS. 1-6 is for illustrative purposes only, and that many other sizes and shapes of the pipe wrench pivot device 100 are well within the scope of the present disclosure. Although the dimensions of the pipe wrench pivot device 100 are important design parameters for user convenience, the pipe wrench pivot device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pipe wrench pivot device that provides a user with a modified pipe wrench capable of pivoting to increase force applied to nuts and bolts, the pipe wrench pivot device comprising:
a head component;
a handle component; and
a pivot pint;
wherein the head component is attached to the handle component;
wherein the pivot pin is secured within the handle component and allows the pipe wrench pivot device to pivot during use; and
further wherein the pivot pin increases force and inertia for the pipe wrench pivot device.

2. The pipe wrench pivot device of claim 1, wherein the head component comprises a fixed jaw and a movable jaw.

3. The pipe wrench pivot device of claim 2, wherein a linear movement is imparted to the movable jaw by a screw and nut arrangement.

4. The pipe wrench pivot device of claim 3, wherein the nut is actuated so that the movable jaw and fixed jaw grip a pipe and then rotatable movement of the nut is repeated to release the pipe.

5. The pipe wrench pivot device of claim 4, wherein the fixed jaw or the movable jaw or both comprise a curved serrated outer edge for better grip of the pipe.

6. The pipe wrench pivot device of claim 5, wherein the handle component is formed as a flat box-like or tubular structure, with a first end and a second end.

7. The pipe wrench pivot device of claim 6, wherein the second end of the handle component is adapted to be gripped by a user in connection with use of the pipe wrench pivot device.

8. The pipe wrench pivot device of claim 7, wherein the first end of the handle component is secured to the head component via a threaded connection, a pin connection, or a rotatable connection.

9. The pipe wrench pivot device of claim 8, wherein the handle component comprises a bottom grip section and a top section secured together via the pivot pin.

10. The pipe wrench pivot device of claim 9, wherein a protrusion is positioned at a top of the bottom grip section, which is sized and shaped to fit within a cavity of the top section.

11. The pipe wrench pivot device of claim 10, wherein the cavity and the protrusion both have a through-hole on either side, which align, such that the pivot pin fits within the through-holes.

12. The pipe wrench pivot device of claim 11, wherein the pivot pin secured to the handle component forms a pivotal connection whereby the bottom grip section may be ratcheted upwards and downwards, to a limited extent relative to the top section of the handle component.

13. A pipe wrench pivot device that provides a user with a modified pipe wrench capable of pivoting to increase force applied to nuts and bolts, the pipe wrench pivot device comprising:
a head component comprising a fixed jaw and a movable jaw;
a handle component which is formed as a flat box-like or tubular structure, with a first end and a second end; and
a pivot pint;
wherein linear movement is imparted to the movable jaw by a screw and nut arrangement;
wherein the nut is actuated so that the movable jaw and fixed jaw grip a pipe and then rotatable movement of the nut is repeated to release the pipe;
wherein the second end of the handle component is adapted to be gripped by a user in connection with use of the pipe wrench pivot device;
wherein the first end of the handle component is secured to the head component via a threaded connection, a pin connection, or a rotatable connection;
wherein the handle component comprises a bottom grip section and a top section secured together via the pivot pin;
wherein a protrusion is positioned at a top of the bottom grip section, which is sized and shaped to fit within a cavity of the top section;
wherein the cavity and the protrusion both have a through-hole on either side, which align, such that the pivot pin fits within the through-holes;
wherein the pivot pin is secured within the handle component and allows the pipe wrench pivot device to pivot during use;
wherein the pivot pin secured to the handle component forms a pivotal connection whereby the bottom grip section may be ratcheted upwards and downwards, to a limited extent relative to the top section of the handle component; and
further wherein the pivot pin increases force and inertia for the pipe wrench pivot device.

14. The pipe wrench pivot device of claim 13, wherein the bottom grip section of the handle component comprises a gripping texture for aiding a user in gripping the handle component during use.

15. The pipe wrench pivot device of claim 13, wherein the pivot pin can be locked and unlocked, as needed.

16. The pipe wrench pivot device of claim 15, wherein the pivot pin comprises a spring and release, which allows a user to lock and unlock the pivoting pin, such that the spring would engage a feature of the handle component to lock the handle component in place.

17. The pipe wrench pivot device of claim 16, wherein a lever is utilized to unlock the pivot pin, which pushes on the spring to unlock it.

18. The pipe wrench pivot device of claim 13 further comprising a plurality of indicia.

19. The pipe wrench pivot device of claim 13, wherein the fixed jaw or the movable jaw or both comprise a curved serrated outer edge for better grip of the pipe.

20. A method of increasing force and inertia on a pipe wrench, the method comprising the following steps:
providing a pipe wrench pivot device comprising a handle component and attached head component with a pivot steel pin in the handle component;
securing the head component around a pipe for use;
pivoting on the steel pin and creating more force when utilizing the wrench; and
increasing the force and inertia on the pipe wrench during use.
